(19) United States
(12) Patent Application Publication
(10) Pub. No.: US 2026/0321996 A1
(43) Pub. Date: Oct. 15, 2026

(54) Insulation Displacement Connector

(71) Applicant: TE Connectivity Solutions GmbH, Schaffhausen (CH)

(72) Inventors: Thomas RAMUNNO, Pontoise (CH); Steven LORD, Pontoise (FR); Xavier ROUILLARD, Pontoise (FR)

(73) Assignee: TE Connectivity Solutions GmbH, Schaffhausen (CH)

(21) Appl. No.: 19/639,338

(22) Filed: Apr. 6, 2026

(30) Foreign Application Priority Data
Apr. 9, 2025 (FR) 2503771

(51) Int. Cl. H01R 4/2433; H01R 13/415; H01R 13/506

(52) U.S. Cl. CPC H01R 4/2433; H01R 13/415; H01R 13/506

(57) ABSTRACT

An insulation displacement connector has at least one piercing terminal, for penetrating wire insulation and making electrical contact to a respective insulated wire in a wire holder; and a closable housing. The closable housing includes a cavity, for holding the wire holder and the at least one piercing terminal; and an internal latching mechanism. The cavity is configured for insertion of the wire holder along an insertion direction.

### CROSS-REFERENCE TO RELATED APPLICATION

This application claims the benefit of French Patent Application No. 2503771 filed on Apr. 9, 2025 in the Institut National de la Propriété Industrielle of France, the whole disclosure of which is incorporated herein by reference.

### BACKGROUND OF THE INVENTION

Electrical connectors are often designed to electrically contact insulated electrical wires, which have a conductive core and an outer insulating layer. Insulation displacement connectors (IDCs), or insulation displacement contacts, can be used for rapidly making electrical connections. IDCs can make electrical contact by, in one rapid operation, piercing the insulation layer and making electrical contact with the core. IDCs may allow foregoing extra steps of insulation stripping, removal and/or insulation disposal, prior to making the electrical connection between the conductive wire and the terminal.

Handling of connectors both during an assembly process for electrical devices, and subsequently, can benefit from strong physical connections between components, which can aid in stabilizing the electrical connection. Stable physical connections can also aid in reducing electrical noise, such as for the case when sensitive signals are passed through the wires. Electrical connections between components are often susceptible to breakage and/or vibrations in shock. It is desirable to have connectors that allow for robust electrical and physical connections between components.

### SUMMARY OF THE INVENTION

Herein, an insulation displacement connector (IDC) is described, particularly one that allows for robust electrical and physical connections. The IDCs herein are suitable for use with wire pairs, e.g. wire pairs that are for differential signal transmission, e.g. along twisted wire pairs. Stable electrical connections aid in reducing electrical problems such as circuit breaks or shorts.

Herein is disclosed an IDC that includes at least one piercing terminal, for penetrating wire insulation and making electrical contact to a respective insulated wire in a wire holder; and a closable housing. The closable housing includes a cavity, for holding the wire holder and the at least one piercing terminal. The IDC includes an internal latching mechanism. The cavity is configured for insertion of the wire holder along an insertion direction.

The above invention may be further improved by adding one or more of the features described in the following, whereby each of these features is advantageous in itself, and may be combined independently and/or in any desired manner with any of the other features described in the following.

The latching mechanism can extend, in the cavity, along the insertion direction. The latching mechanism can be configured for insertion into the wire holder in the cavity. The cavity can be configured for insertion of the wire holder therein, along the insertion direction.

The latching mechanism can be configured to pass through the wire holder in the cavity; and the latching mechanism can be inserted into the wire holder during introduction of the wire holder into the cavity.

The closable housing can include a cover and base. The cover can be latched to the base of the closable housing. The latching mechanism can latch the housing cover, and/or latch the housing base to the wire holder.

The internal latching mechanism can include at least one arm. The arm(s) can extend, along the insertion direction, from an inner wall of the closable housing when the IDC is in a closed configuration. The at least one arm is configured to at least one of: go through the wire holder in the cavity; to pass next to the at least one piercing terminal; or to be inserted into a receptacle of the closable housing. For example, the arm(s) pass through the wire holder to a receptacle of the closable housing, and pass next to the piercing terminal(s).

The at least one arm can be configured to go through the wire holder and latch to at least one of:
an outer surface of the wire holder in the cavity; the closable housing; an inner surface of the closable housing; another arm; or a surface of the cavity.

The at least one arm can be inserted into the receptacle of the closable housing; and, at least one of: the cover of the housing includes the receptacle, the base of the housing includes the receptacle, or the receptacle is at a surface of the cavity.

A respective end of the at least one arm can include a respective latching element. The respective latching element can latch to the wire holder in the cavity, and/or latch the base and the cover of the closable housing together.

The latching mechanism can include at least one second arm, oriented along the insertion direction that is configured to extend into or through the wire holder from an opposite inner wall of the closable housing.

The at least one arm and the at least one second arm can latch together.

The arm(s) of the housing cover can latch to the base end of the opposite arm of the latch of the housing base. The arm(s) can be configured to extend into/through the wire holder. The arm(s) can go to an opposite wall of the cavity, e.g. from the housing base to the housing cover, e.g. along the insertion direction.

The latching mechanism can include an opposite arm, oriented along the insertion direction that is configured to extend into/through the wire holder from an opposite inner wall of the closable housing.

Arms can have hooks/openings for securing the closable housing in a closed state.

The latch of the housing cover can be configured to pass through the wire holder, such as a window thereof.

In a closed configuration, the cover and base can be fixed by the latching mechanism, possibly irreversibly. An irreversible mechanism may enhance stability.

In the closed configuration of the IDC, the arm of the latching mechanism can extend from a wall of the cavity toward the cover; and the wall, from which the arm of the latching mechanism extends, can be an inner wall of the base of the housing.

The at least one piercing terminal of the IDC can include a piercing end extending along the insertion direction.

The at least one piercing terminal of the IDC can include blade(s), e.g. at a boundary [bottom] of the cavity. Blades can extend parallel to the insertion axis. Blades can extend into the cavity. Blades can extend from the base of the housing.

The closable housing can be configured to fix the wire holder therein.

The housing base can hold an insulation piercing terminal such as a blade. The insulation piercing terminal can be configured for insertion in the wire holder.

The IDC can include the wire holder.

The wire holder can include at least one hole for providing access to the wire pair in the wire holder. Alternatively/additionally, the wire holder can include a wire holder cover and/or wire holder base that includes the window.

The wire holder can have beveled sides; the beveled sides can be configured to contact inside walls of the closable housing. The beveled sides can contact the inner walls of the cavity for centering the wire holder in the housing.

The wire holder can include a holder base and holder cover. In an assembled state of the wire holder, the holder base and holder cover can form at least one hole, e.g. where the holder base and holder cover join. The hole(s) can be for at least one wire to pass therethrough, e. g at a seam. The hole(s) can clamp the wires. The hole(s) can control the pitch between the wire(s). The openings can be round. The openings can pass through a face of the wire holder. The opening(s) can include a curved boundary formed by a surface of at least one of the holder base and the holder cover. Providing such an opening can aid in stabilizing the position of the wire.

The holder base and holder cover can be configured to clamp the ends of a pair of wires. The wire holder base and wire holder cover can be reversibly attachable. Reversibility may be convenient for users.

The inside of the holder base can include a pressing member for pressing the wire pair against the piercing terminal(s), e.g. blade(s), for electrically contacting the wires of the wire pair through the insulation of the wire pair; the pressing surface can be in the window's footprint perpendicular to the insertion direction. The pressing surface can aid in making/maintaining electrical contact. The position of the pressing member(s) can be, when projected along the insertion direction, between the blades of a piercing terminal, the blades of the terminal being displaced with respect to each other along the long axis of the wire.

The IDC can include a ridge between the piercing terminals in the cavity. This may improve insulation and/or mechanical stability.

Herein is disclosed a wire holder. The wire holder can include at least one window. The at least one window can be configured for passing a latching mechanism of a closable housing therethrough. The wire holder can be configured to be inserted, along an insertion direction, into a cavity of the closable housing. The wire holder can be configured to allow at least one piercing terminal, held in the cavity, to penetrate wire insulation and make electrical contact to a respective insulated wire held in the wire holder, when the wire holder is inserted into the cavity.

The wire holder can include a holder base and holder cover. The holder base and holder cover can latch together, e.g. reversibly. The end(s) of at least one wire can be held in the wire holder, e.g. before and/or after the wire holder is inserted into the cavity.

The wire holder can be configured to be sandwiched by the base and cover of the closable housing of the IDC. The wire holder can be latched to the closable housing, e.g. to at least one of the base or cover of the housing.

The wire holder can be configured such that the internal latching mechanism of the IDC is insertable through the wire holder, e.g. when the wire holder is inserted into the cavity of the IDC. The wire holder can be configured to allow the internal latching mechanism to pass therethrough. For example, the internal latching mechanism can go through the wire holder and latch to an outer surface of the wire holder.

The wire holder can be configured such that the latching mechanism can latch the housing base to the wire holder.

The wire holder can include at least one window, e.g. through which the latching mechanism, and/or components thereof, can pass. For example, arm(s) the latching mechanism can pass through the window(s) of the wire holder, when the wire holder is in the cavity.

The at least one window can be for the latching mechanism and/or piercing terminal(s) to pass through. The at least one window can allow the passage of at least one arm of the latching mechanism. For example, a first window can allow an arm from a cover of the housing and an arm from a base of the housing. A second window of the wire holder can allow a second arm from the cover and a second arm from the base to pass therethrough.

The window(s) can accept insertion of respective arm(s) along the insertion direction, such as to stabilize the assembled IDC. Arm(s) of the latching mechanism which pass through the wire holder 200 can stabilize the electrical connection between the conductive part of the wire(s) 160 and the piercing terminal(s).

Any one or more of the window(s) can be slots.

The wire holder can latch together, such as to clamp the wire(s), e.g. the respective end(s) thereof. The wire holder can include a latching structure, e.g. for latching multiple pieces of the wire holder together, e.g. a base and cover of the wire holder.

The wire holder is configured for insertion into the cavity of the closable housing of the IDC, e.g. along the insertion direction. The window(s) of the wire holder can guide the insertion, e.g. constrain the insertion to be along the insertion direction. The wire holder can be configured such that the internal latching mechanism extends, in the cavity, along the insertion direction. The internal latching mechanism, such as arm(s) of the latching mechanism, can extend through the wire holder and/or extend so as to be flush with an outer surface of the wire holder.

The wire holder can have at least one hole for allowing respective wire(s) to pass into the wire holder. The optional wire holder base and holder cover can, in an assembled state, form the hole(s). The hole(s) can be formed at a seam, e.g. where a face of the wire holder is formed from the base and cover, e.g. when joined. The hole(s) can control the pitch of the wire(s). The hole(s) can be round, and match the size of the wire(s). The hole(s) can be formed by curved surfaces of at least one of the holder base and holder cover when assembled (e.g. latched) together. The radius of curvature of the curved surface(s) of the base and/or cover of the holder can designed so as to match that of the wire(s) intended for connection with the IDC.

At least one side of the holder, the holder base, or the holder cover can have respective notch(es), to allow respective wire(s) to pass through, e.g. first and second notches for first and second wires. Alternatively/additionally, the notch(es) can form the respective holes, e.g. when the holder base and cover are assembled together.

The wire holder, such as the wire holder base thereof, can include at least one pressing member for pressing the wire(s) toward the piercing terminal(s). The pressing member(s) can aid in ensuring electrical contact between the wire(s) and the piercing terminal(s). The pressing member(s) can extend from an inside wall of the wire holder and/or holder base. The pressing member(s) can press respective wire(s), in a direction perpendicular to their longitudinal axis (axes) during insertion of the wire holder into the cavity.

The wire holder can include beveled contact surfaces that are configured to contact, at least partially, inner walls of the housing and/or cavity. The bevels can aid in guiding the wire holder into the cavity.

The wire holder can hold the end(s) of wire(s).

### BRIEF DESCRIPTION OF THE DRAWINGS

In the following, the invention will be explained exemplarily and in more detail with reference to the drawings and in accordance with several embodiments, the different features of which can be combined with one another as desired in accordance with the above general description. Moreover, a feature may be omitted from the below embodiments if its technical effect is not required in a particular application. Likewise, a feature described above that is not present in an embodiment as described below may be added if its technical effect is not essential for a particular application.

In the following, the same reference numerals are used for elements that correspond to each other with respect to at least one of structure and function.

FIG. 1 shows an exploded view of an insulation displacement connector, or IDC, according to an embodiment;

FIG. 2 shows a closable housing of an IDC, according to an embodiment;

FIG. 3 shows an IDC, according to an embodiment;

FIG. 4 shows an IDC in a closed configuration, according to an embodiment;

FIG. 5 illustrates an IDC, according to an embodiment;

FIG. 6 illustrates a wire holder, according to an embodiment;

FIG. 7 illustrates a wire holder or wire holder base, according to embodiments;

FIG. 8 illustrates a partially assembled IDC, according to an embodiment;

FIG. 9 illustrates an assembled IDC; and

FIG. 10 illustrates a piercing terminal, according to an embodiment.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

In the following, an IDC and components thereof, according to several possible embodiments, will be described with reference to the figures, which are illustrative. Embodiments are not limited to those shown in the figures.

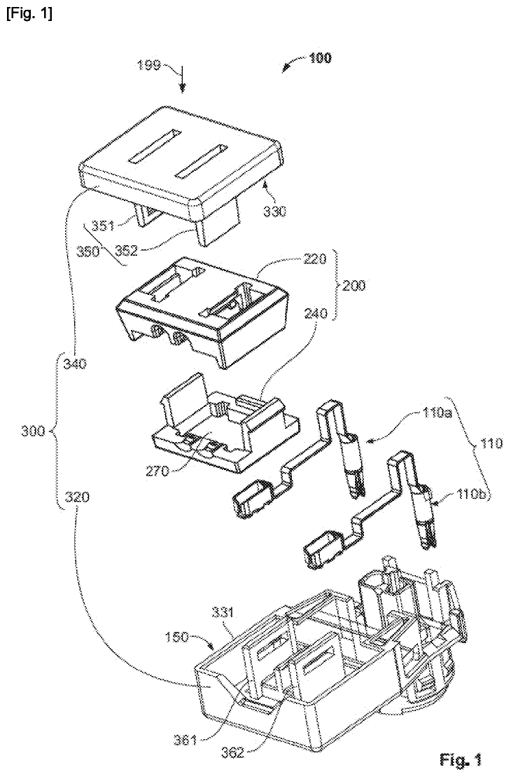

FIG. 1 illustrates an IDC, in an exploded view, according to an embodiment. An IDC 100 can include a piercing terminal 110 and a closable housing 300, e.g. the housing 300 including a base 320 and cover 340. The piercing terminal 110, which can include one or more blades, can penetrate wire insulation and make electrical contact to an insulated wire, such as a wire in a wire holder 200. The housing 300 can include a cavity 150 that holds the wire holder 200 and the piercing terminal 110. The wire holder 200 can be inserted into the cavity 150, along an insertion direction 199.

The wire holder 200 can include a holder base 220 and holder cover 240, as shown in FIG. 1. The holder base 220 and holder cover 240 can latch together, e.g. reversibly. The end(s) of at least one wire can be held in the wire holder 200, e.g. before the wire holder 200 is inserted into the cavity 150.

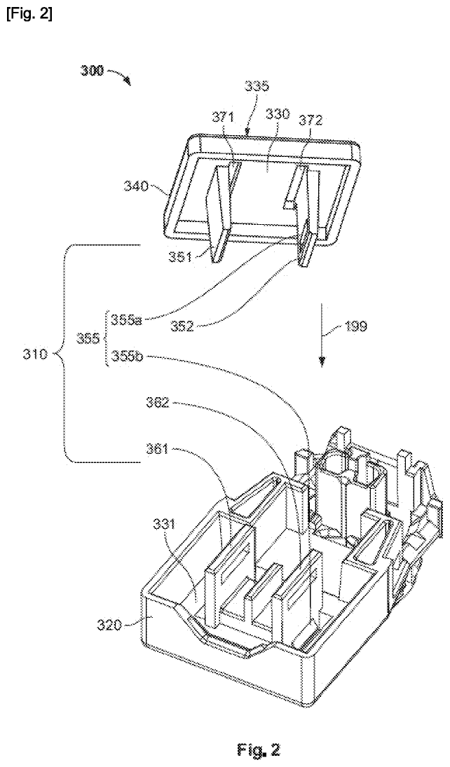

FIG. 2 illustrates a closable housing of an IDC, according to an embodiment. The housing 300 can include a base 320 and cover 340, as illustrated. The housing 300 described herein with respect to FIG. 2 can be combined with any embodiment of the IDC 100 described herein.

The housing 300 can include an internal latching mechanism 310, e.g. a latching mechanism 310 that extends in the cavity 150, along the insertion direction 199. The internal latching mechanism 310 can be inserted into the wire holder 200 when the wire holder 200 is inserted into the cavity 150. The internal latching mechanism 310 can go through the wire holder 200, at least partially. For example, the internal latching mechanism 310 can go through the wire holder 200 and latch to an outer surface of the wire holder 200.

The closable housing 300 that may include a cover 340 and base 320, such as that illustrated in FIGS. 1 and 2, can include the latching mechanism 310 that latches the base 320 to the cover 340. The latching mechanism 310 can pass through the wire holder 200. Alternatively/additionally, the latching mechanism 310 can latch the housing base 320 to the wire holder 200.

The latching mechanism 310 can include at least one arm 350. The arm(s) 350 can extend along the insertion direction 199. The arm(s) 350 can include the arm(s) 351, 352, 361, 362, e.g. an arm(s) 351 that extends, along the insertion direction 199, from an inner wall 330 of the housing 300. The arm(s) 351 can extend into the wire holder 200, in the cavity 150, such as in a closed configuration of the IDC 100. The arm(s) 351 can extend from the inner wall 330 toward an opposite inner wall 331 of the housing 300, when the housing 300 is closed. The arm(s) 351 can extend from the inner wall 330 and reach the opposite inner wall 331.

For example, the arm(s) 351, 352 extend from the inner wall 330 of the cover 340 to an opposite inner wall 331 of the base 320. The arm 351 that extends from the cover 340 to the base 320 may attach to the base 320 by latching.

The latching mechanism 310 can include complementary latching elements 355, e.g. to form a slam latch. For example, the arm 351 and/or second arm 352 can have a latching element 355a, such as a notch. At the opposite inner wall 330, there can be a complementary latching element 355b, such as a protrusion. Latching elements 355 can be in pairs, e.g. for latching together components of the housing 300 (e.g. the base 320 and cover 340) and/or the housing 300 and the wire holder 200.

The complementary latching element 355b to a latching element 355a (e.g. the latching element 355a of an arm 352) can be at a root end of an opposite arm 361 (e.g. second opposite arm 361). The opposite arm 361 can extend from the opposite inner wall 331 of the housing 300, e.g. the opposite arm 361 can extend from the base 320.

For example, the latching mechanism 300 can include complementary latching elements 355, e.g. at least one latching pair, e.g. a latching tooth or protrusion 355b and complementary notch 355a, that latch together. At least one of the latching pair can be on the arm 351, such as at the end of the arm 351.

The latching mechanism 310 can include an opposite arm 361, oriented along the insertion direction 199. The opposite arm 361 can extend into/through the wire holder 200. The opposite arm 361 can extend from an opposite inner wall 331 of the closable housing 300 toward the inner wall 330.

The arm(s) 351, 352, 361, 362 of the latching mechanism 310 can each have at least one latching element 355a, 355b, e.g. at an end thereof. For example, the second arm 352 includes a latching element 355a at the end of the second arm 352.

Alternatively/additionally, the arm(s) 351, 352, 361, 362 may be guides, which aid in the correct placement of the wire holder 200 in the cavity 150, and/or respective alignment of the base 320, cover 340, and/or wire holder 200. For example, the cover 340 can include a receptacle(s) 370 for receiving an end of the opposite arm(s) 361, 362 of the base 320. The receptacle(s) 371, 372 can be slot(s) which can complement the shape of the ends of the opposite arm(s) 361, 362, e.g. when the opposite arm(s) 361, 362 are tab(s). The opposite arm(s) 361, 362 can pass through the wire holder 200 in the cavity 150. When the housing 300 is closed, the ends of the opposite arm(s) 361, 362 can fit in the receptacle(s) 371, 372, e.g. so that the end face(s) of the opposite arm(s) 361, 362 are flush with the outer surface of the housing 300, such as the top 335 of the cover 330.

The wire holder 200 can include at least one window 270 (see FIG. 1) through which the latching mechanism 310, and/or components thereof, can pass. For example, arm(s) 361, 362 of the latching mechanism 310 (see FIG. 2) can pass through the window(s) 270 of the wire holder 200, when the wire holder 200 is in the cavity 150.

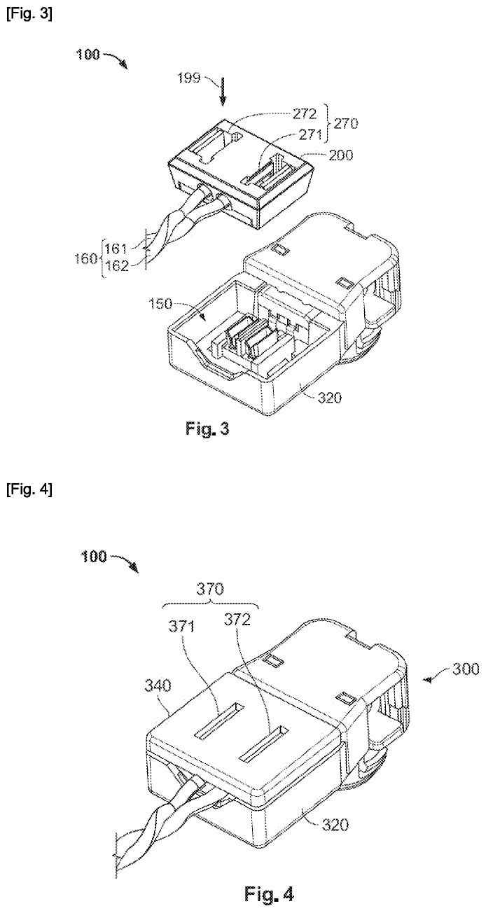

FIG. 3 illustrates an IDC, according to an embodiment. The features of the IDCs 100 described with respect to FIG. 3 can be combined with any other embodiment of the IDC 100 described herein. The IDC 100 can include the closable housing 300 that includes the cavity 150 and piercing terminal(s) 110. The cavity 150 can hold the wire holder 200 and the piercing terminal(s) 110.

The wire holder 200 can be inserted into the cavity 150 of the closable housing 300 of the IDC 100, e.g. along the insertion direction 199. The internal latching mechanism 310 of the housing 300 can latch to the wire holder 200. The internal latching mechanism 310 can extend, in the cavity 150, along the insertion direction 199. The internal latching mechanism 310, such as arm(s) 350 of the latching mechanism 310, can extend through the wire holder 200 and/or extend so as to be flush with an outer surface of the wire holder 200.

For example, arm(s) 361, 362 of the internal latching mechanism 310 of the closable housing 300 can latch to the wire holder 200. The housing 300 of the IDC 100 can be closed by insertion of the wire holder 200 into the cavity 150; the insertion possibly including the latching together of the wire holder 200 and housing 300. Complementary latching elements 355 of the housing 300 and wire holder 200 can latch together, e.g. reversibly.

The wire holder 200 can have at least one hole 250 for wire(s) to pass through. The wire holder 200 can hold the end(s) of respective wire(s) 160, e.g. a wire pair 161, 162. The wire holder 200 can hold the wire(s) 160 so that the longitudinal axis of the wire(s) 160 are oriented substantially perpendicular to the insertion direction 199.

The wire holder 200 can have at least one window 270 for the latching mechanism 310 to pass through. The at least one window 270 can allow the passage of at least one arm 351, 352, 361, 362 extending from the closable housing 300, e.g. the base 320 or cover 340 thereof. For example, a first window 271 can allow an arm 351 from a cover 340 and an arm 361 from a base 320 to pass therethrough. A second window 272 can allow a second arm 352 from the cover 340 and a second arm 361 from the base 320 to pass therethrough. The window(s) 271, 272 can accept insertion of respective arm(s) 351, 361 along the insertion direction 199, such as to stabilize the assembled IDC 100. Arm(s) 351, 361 of the latching mechanism 310 which pass through the wire holder 200 can stabilize the electrical connection between the conductive part of the wire(s) 160 and the piercing terminal(s) 110.

The window(s) 271, 272 can be slots.

The arm(s) 351, 352, 361, 362 can be tab(s), with a long axis and short axis which are each perpendicular to the insertion direction 199. The tab(s) can be oriented along the insertion direction 199, e.g. extending from the inside surface of the closable housing 300. The tab(s), or arm(s) 351, 352, 361, 362 can pass through corresponding slots of the wire holder 200. Alternatively/additionally, the tabs can insert into complementary slots (which may be through holes or blind holes) in the closable housing 300. The tab(s) can act as guides. The arm(s) 351, 352, 361, 362 and/or tab(s) can aid in stabilizing the IDC 100, e.g. when the IDC 100 is in a closed configuration and/or holding wire(s) 160 making electrical contact with the piercing terminal(s) 110.

FIG. 4 illustrates an IDC, according to an embodiment. The closable housing 300 can include the cover 340, as in the illustration of FIG. 4. The cover 340 can close the closable housing 300, e.g. by latching to the base 320 and/or the wire holder 200. FIG. 4 illustrates a closed configuration of the IDC 100.

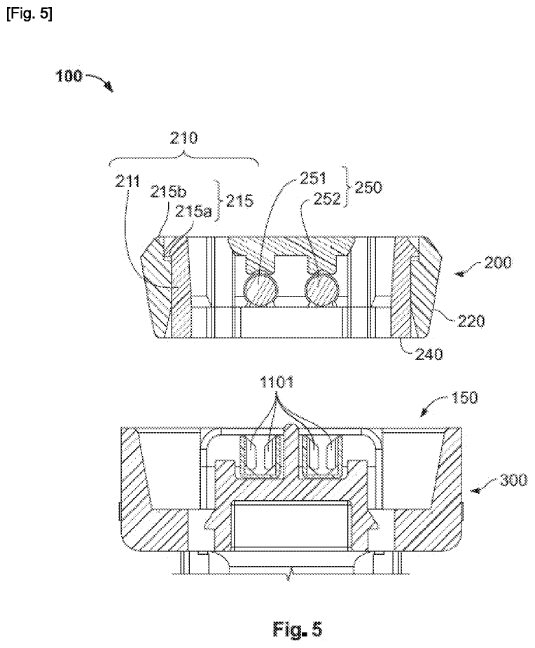

FIG. 5 illustrates an IDC, according to an embodiment. The closable housing 300 of the IDC 100 can be closed by insertion of the wire holder 200. The wire holder 200 can be separated from the housing 300, for example. The wire holder 200 can be reversibly inserted into the cavity 150 of the housing 300. Optional latching between the wire holder 200 and housing 300 can be undone.

The wire holder 200 can include a holder base 220 and holder cover 240. A latching structure 210 can latch the base 220 and cover 240 together. The latching structure 210 of the wire holder 200 can include at least one arm 211. Alternatively/additionally, the latching structure 210 of the wire holder includes complementary latching elements 215, e.g. a protrusion 215a and notch 215b. When latched together, the wire holder 200 can hold, e.g. clamp the wire(s). The wire(s) 160 can be held by the wire holder 200, for example, while the wire holder 200 is inserted into the cavity 150 and/or while the insulation of the wire(s) 160 is pierced by the insulation piercing terminal(s) 110. Alternatively/additionally, the wire holder 200 can hold the wire(s) 160 in the cavity 150 of the assembled IDC 100.

The closable housing 300 can be configured for fixing the wire holder 200 therein.

The internal latching mechanism 310 of the closable housing 300, described herein, can work synergistically with the latching structure 210 of wire holder 200 described herein, e.g. to provide an IDC 100 that maintains robust electrical connections even when exposed to shock or vibration.

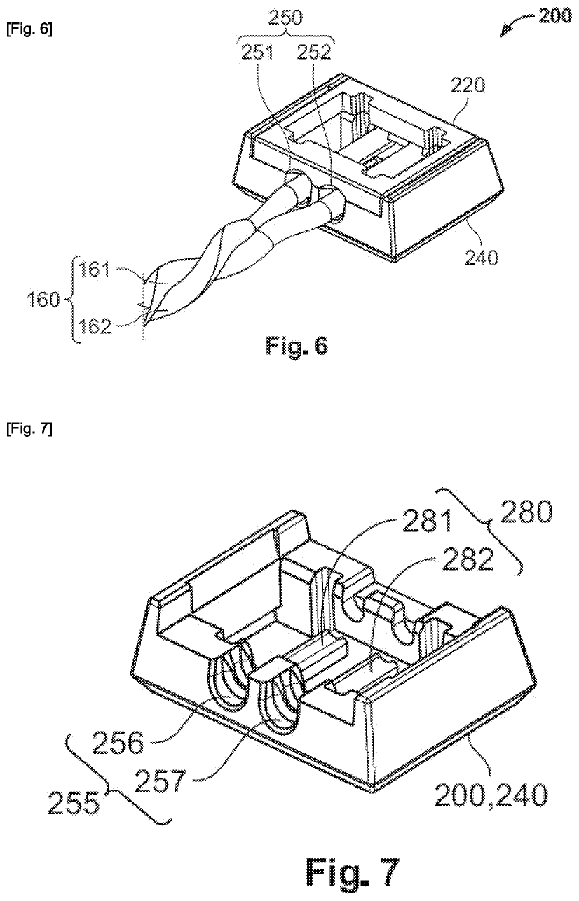

FIG. 6 illustrates a wire holder, according to an embodiment. The wire holder 200 can include at least one hole 250 to allow at least one wire 160, such as a respective end thereof, to pass into the wire holder 200, such as two holes 251, 252. The hole(s) 250 can be round, e.g. so that each wire passes through a respective hole 251, 252. The hole(s) 250 can be formed by assembly of the wire holder 200 which can include the holder base 220 and holder cover 240.

The wire holder 200 can latch together, such as to clamp the wire(s) 160, e.g. the respective end(s) thereof. The wire holder 200 can include a latching structure 210, which can be seen in FIG. 5.

The holder base 220 and holder cover 240 can, in an assembled state, form the at least one hole 250 for at least one wire 160 to pass therethrough. The hole(s) 250 can be formed at a seam, e.g. where a face of the wire holder 200 is formed from the base 220 and cover 240. The hole(s) 250 can control the pitch of the wire(s) 160. The hole(s) 250 can be round, and match the size of the wire(s) 160. The hole(s) 250 can be formed by curved surfaces of at least one of the holder base 220 and holder cover 240 when assembled (e.g. latched) together. The radius of curvature of the curved surface(s) of the base 220 and/or cover 240 of the holder 200 can adesigned so as to match that of the wire(s) 160 intended for connection with the IDC 100.

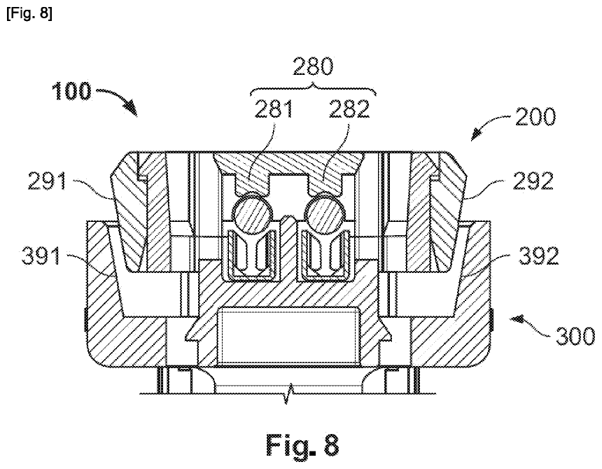

FIG. 7 illustrates a wire holder or wire holder base, according to embodiments. At least one side of the holder 200, holder base 220, or holder cover 240 can have respective notch(es) 255, to allow respective wire(s) to pass through, e.g. first and second notches 256, 257 for first and second wires 161, 162. Alternatively/additionally, the notch(es) 255 form the respective holes 220, e.g. when the holder base 220 and cover 240 are assembled together.

The wire holder 200, cover 240, and/or wire holder base 220 can include at least one pressing member 280 for pressing the wire(s) 160 toward the piercing terminal(s) 110. The pressing member(s) 280 can aid in ensuring electrical contact between the wire(s) 160 and the piercing terminal(s) 110. The pressing member(s) 280 can extend from an inside wall of the wire holder 200 and/or holder base 220. The pressing member(s) 280 can press respective wire(s) 160, in a direction perpendicular to their longitudinal axis (axes), e.g. during insertion of the wire holder 200 into the cavity 150. The pressing member(s) 280 can be on the opposite side of the wire(s) 160 as the piercing terminal(s) 110. The pressing member(s) 280 can aid in piercing the insulation of the wire(s) 160 when the wire holder 200 is inserted into the cavity 150. Alternatively/additionally, the pressing member (2) 280 can aid in making/maintaining electrical contact between the wire(s) 160 and the piercing terminal(s) 110. The pressing member(s) 280 can press against the opposite side of the wire(s) 160 as the piercing terminal(s) 110. The pressing member(s) 280 can aid in maintaining robust electrical contact.

The pressing member(s) 280 can have a concave surface(s), e.g. to complement the cylindrical shape of a wire and/or to press against the respective wire(s) 160. The radius of curvature of the curved surface(s) can designed so as to match that of the wire(s) 160 intended for connection with the IDC 100.

The piercing terminal(s) 110 are for penetrating wire insulation and making electrical contact to an insulated wire in the wire holder 200 when the wire holder 200 is inserted into the cavity 150. The wire holder 200 is inserted along the insertion direction 199 into the cavity 150. Insertion can be complete when the wire holder 200 is latched to the closable housing 300. Complementary latching elements 355 can latch the wire holder 200 to the housing 300, e.g. closing the closable housing 300. Alternatively/additionally, the closable housing 300 can be closed after the wire holder 200 is inserted into the cavity 150 and the housing cover 340 is latched to the housing base 320, e.g. by complementary latching elements 355 on the housing cover 340 and housing base 320 and/or wire holder 200.

The piercing terminal(s) 110 can be at a boundary of the cavity 150 and/or be considered to be part of the cavity 150. The wire holder 200, when inserted into the cavity 150 can allow the piercing terminal(s) 110 to pass into the wire holder 200. The piercing terminal(s) 110 can extend parallel to the insertion axis 199. For example, the piercing terminal(s) 110 are at a bottom surface of the cavity 150 and/or extend from the base 320 of the closable housing 300. The piercing terminal(s) 110 can include blades, which can be configured for cutting the insulation of the wire(s) 160 and electrically contacting the metal wire inside. The closable housing 300 and/or base 320 thereof can hold the insulation piercing terminal(s) 110. This may increase stability and provide robust electrical contact even when the IDC 100 is exposed to shock and vibration.

An IDC 100 that includes a closable housing 300 can improve resistance to shock and vibration. Protection from shock and vibration can be further improved when the housing 300 includes the base 320 and cover 340 that are latched together, e.g. enclosing the wire holder 200 in the cavity 150 of the housing 300. Alternatively/additionally, the wire holder 200, acting to hold the insulation piercing terminal(s) 110 can improve stability; such stability can be further enhanced by using the pressing member 280 that can stabilize the position of the wire(s) 160 against the piercing terminal(s) 110.

The piercing terminal(s) 110 can be between arm(s) 361, 362 of the latching mechanism 310. The arm(s) 361 can aid in holding the piercing terminal(s) 110 in place. Alternatively/additionally, a respective ridge 380 can be between the piercing terminal(s) 110, such as that labeled in FIG. 2. The ridge 380 can aid in holding the piercing terminal(s) 110 and/or aid in preventing shorting of the wires or electrical cross-talk.

FIG. 8 illustrates a partially assembled IDC, according to an embodiment. The wire holder 200 can include beveled sides and/or beveled contact surfaces 291, 292 that contact, at least partially, inner walls 330 of the housing 300 and/or cavity 150. The bevels can aid in guiding the wire holder 200 into the cavity 150. The closable housing 300 can include complementary beveled contact surfaces 391, 392. The complementary beveled contact surfaces 391, 392 can contact the beveled contact surfaces 291, 292. Complementary beveled contact surfaces 391, 392 can enhance stabilization of the IDC 100, and maintain strong electrical connection, even in an environment exposed to vibration and shock.

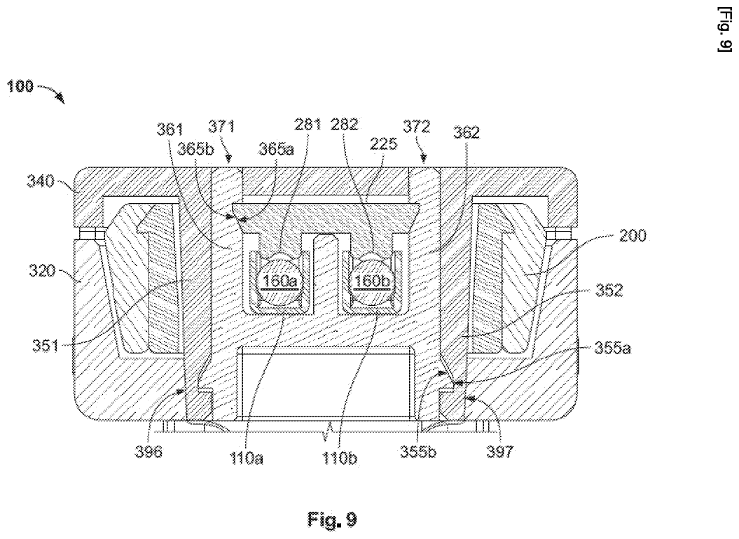

FIG. 9 illustrates an assembled IDC, according to an embodiment. The IDC 100 can optionally include a housing cover 340 which may latch to the housing base 320, as illustrated in FIG. 9.

The internal latching mechanism 310 can go through the wire holder 200; for example, the internal latching mechanism 310 can include arm(s) 361, 362 that go through the wire holder 200 and latch to an outer surface 225 of the wire holder 200. The outer surface 225 can be within the cavity 150 of the closable housing 300. The arm(s) 361 362 can be received in respective receptacle(s) 371, 372 of housing cover 340. The receptacle(s) 371, 372 can be slot(s), e.g. through the cover 340.

The internal latching mechanism 310 can include at least one arm 361, 362. The arm(s) 361, 362 can: go through the wire holder 200 and latch to an outer surface 225 of the wire holder 200 in the cavity 150; pass next to a piercing terminal 110a, 110b; insert into a receptacle(s) 370 of the closable housing 300, such as a receptacle 371, 372 of the cover 340 of the housing 300; include a respective latching element 365a of a pair of complementary latching elements 365a, 365b, e.g. at an end of the arm 361, 362, e.g. for latching to the wire holder 200. The arm(s) 361, 362 can, alternatively/additionally: include a latching element 355b of a pair of complementary latching elements 355a, 355b at an opposite end of the arm 361, 362, the opposite end being nearer the inside wall 330 of the closable housing 300 from which the arm(s) 361, 362 extend, e.g. for latching the base 320 and cover 340 of the closable housing 300 together; or any combination of the above. Further latching element pairs 365a, 365b; 355a, 355b can aid in providing a stable connector, resistant to vibration or shock.

Alternatively/additionally, the internal latching mechanism 310 can include at least one arm 351, 352. The arm(s) 351, 352 can go through the wire holder 200 and/or latch to the closable housing 300, e.g. at an inner surface, at another arm 361, 362 and/or at the surface of the cavity 150. Alternatively/additionally, the arm(s) 351, 352 can pass next to a piercing terminal 110a, 110b; and/or the arm(s) 351/352 can insert into a receptacle 396, 397 of the closable housing 300, such as a receptacle 396, 397 at the base 320 of the housing 300 and/or at a surface of the cavity 150. Alternatively/additionally, the arm(s) 351, 352 can include a latching element 355a of a pair of complementary latching elements 355a, 355b at an end of the arm 351, 352, e.g. for latching to the base 320 of the closable housing 300 and/or latching to another arm 361, 362.

It can be advantageous for the latching mechanism 310 to have more than one pair of complementary latching elements 355a, 355b, in order to increase security and protect the electrical connection from vibration and/or shock.

The internal latching mechanism 310 described herein can include at least one set (e.g. a pair) of complementary latching elements 355 between (a) the closable housing 300 and the wire holder 200; (b) the base 320 of the closable housing 300 and the wire holder 200; and (c) the cover 340 of the closable housing 300 and the base 320 of the closable housing 300. Alternatively/additionally, complementary latching elements 355a, 355b can be between the cover 340 of the closable housing 300 and the base 320 of the closable housing 300, for latching the closable housing 300 to a closed configuration.

The various forms of the latches described herein are each optional, and can be used to adequately secure any combination of the wire holder 200, wire(s) 160, and/or closable housing 300.

For example, as shown in FIG. 9, there can be complementary latching pairs 365a, 365b that latch the wire holder 200 to the closable housing 300, e.g. the cover 340 thereof. The latching element 365a of the wire holder 200 can be at the surface of the wire holder 200, e.g. the outer surface 225. The respective ends of arm(s) 361, 362 of the latching mechanism 310 can latch to the surface of the wire holder 200, e.g. the outer surface 225. The arm(s) 361, 362 can extend from the inside wall of the closable housing 300, the cavity 150, and/or the base 320 of the closable housing 300.

Alternatively/additionally, the IDC 100 can include complementary latching pairs 355a, 355b that latch the cover 340 of the closable housing 300 to the base 320 of the closable housing 300. The latching element(s) 355a of the housing cover 340 can be at the respective end(s) of arm(s) 351, 352 of the latching mechanism 310. The arms 351, 352 can extend from an inside wall of the closable housing 300, e.g. from an inside wall of the cover 340 of the closable housing 300.

The arm(s) 350 of the latching mechanism 310, such as the arms 351, 352, 361, 362, can extend through the wire holder 200, such as in the closed configuration, e.g. the configuration shown in FIG. 9. The wire holder 200 can include at least one window 270 and/or passage to allow the arm(s) 350 and/or latching mechanism 310 to pass through. The arm(s) 350 and/or latching mechanism 310 can extend along the insertion direction 199.

Alternatively/additionally, in the closed configuration of the IDC 100, the arm(s) 350 of the latching mechanism 310 can extend from a wall of the cavity 150 toward an opposite wall. For example, as illustrated in FIG. 9, the arm(s) 361, 362 can extend toward a wall of the cover 340 of the closable housing 300; the arms 361, 362 can extend from an inner wall of the base 320 of the closable housing 300. Alternatively/additionally, the arm(s) 351, 352 can extend from an inner wall of the cover 340 toward the base 320 of the closable housing 300.

In the closed configuration, the cover 340 and base 320 of the housing 300 can be irreversibly latched together. This may aid in providing stability.

As mentioned, in the closed configuration of the closable housing 300, the latching mechanism 310 can pass through the wire holder 200. For example, at least one arm 350 passes through the wire holder 200 in the cavity 150, when the IDC 100 is in the closed configuration. The wire holder 200 can have at least one window that allows the passage of the at least one arm 350 of the latching mechanism 310 through the wire holder 200. The same window or an additional window of the wire holder 200 can allow the insertion of the piercing terminal(s) 110 into the wire(s) 160.

The piercing terminal(s) 110 described herein can be held by the housing base 320. The piercing terminal(s) 110 described herein can be inserted into the wire holder 200.

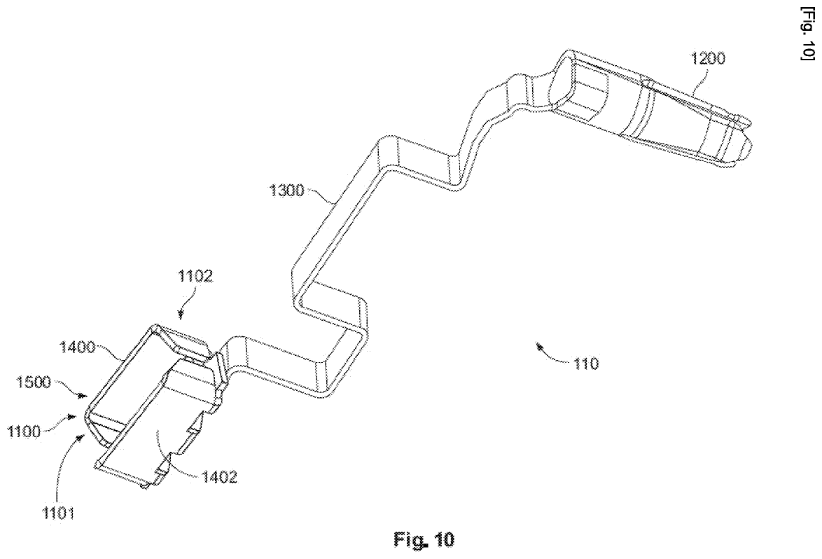

FIG. 10 illustrates a piercing terminal, according to an embodiment, combinable with any embodiment described herein. The piercing terminal(s) 110 described herein can have a piercing end 1100 at a first end. The piercing terminal(s) 110 can have a second end 1200, such as a non-piercing end. The piercing terminal(s) 110 described herein can include blade(s) 1101, 1102, for piercing the insulator and making electrical contact with the wire(s) 160, particularly at the piercing end 1100.

For example, the piercing terminal 110 includes a pair of blades 1101 and a second pair of blades 1102, separated by a distance. Between the pairs of blades 1101, 1102, there can be walls 1400, 1402 of the piercing terminal 110. The walls 1400 can extend along the direction separating the pairs 1101, 1102 of blades. The walls 1400, 1402 can form a channel(s) 1500 for respective wire(s) 160 to be placed therein, so that the respective wire(s) 160 can fit in the channel 1500 and be pierced by the blades 1101, 1102 for electrical contact. The channel 1500 can be in the cavity 150 of the housing 300. The channel 1500 can be oriented to allow the longitudinal axis of the wire 160 to be held therein. Alternatively/additionally, the channel 1500 can be oriented such that, when the wire holder 200 is in the cavity 150, the channel 1500 opens toward the hole(s) 250 of the wire holder 200. Wire(s) 160 that are held by the wire holder 200 can be in respective channel(s) 1500 when the wire holder 200 is held in the cavity 150.

The second end 1200 of the piercing terminal 110 can include a second terminal end, e.g. a female terminal end or male terminal end for further connecting the IDC 100 to other electrical components. A conductive intermediary member 1300 can electrically connect the first and second ends 1100, 1200.

The IDC 100 described herein is particularly contemplated to be used with wire pairs, e.g. in connecting twisted wire pairs to terminals. The stability of the IDC described herein can provide tight noise tolerances, which can be suitable for signal transmission with low noise. The enhanced stability provided to the electrical contact between the wires 161, 162 and the piercing terminals 110 due to, for example, the latching mechanism 310 which passes through the wire holder 200, can reduce susceptibility to electrical noise due to vibration and/or provide a robust electrical connection resistant to shock and vibration. For example, arm(s) 350 of the latching mechanism may pass alongside the piercing terminals 110, through the cavity 150 and/or wire holder 200, and provide enhanced mechanical stability. The arm(s) 350 can act synergistically with complementary opening(s) such as the window(s) 270 of the wire holder 200 and/or receptacle(s) 370 of the closable housing 300, e.g. by passing therethrough. The window(s) 270 and receptacle(s) 370 can stabilize the position of the arm(s) 350. The window(s) 270 and/or receptacle(s) 370 can act to guide the position of the arm(s) 350.

As shown in FIG. 4, the cover 340 of the closable housing 300 can include a first and second receptacle 371, 372 that accepts the respective ends of arms 361, 362. The receptacle(s) 370 can be slots or grooves and can be a complementary shape of the ends of the arms 361 362 which are receivable therein. For example, arm(s) 351 can be tabs, and the complementary receptacle(s) 370 of the housing 300 can be slots.

Herein, “housing” can be used interchangeably with “closable housing.” Herein, an “internal latching mechanism” can be a latching mechanism that extends in a cavity of an IDC, such as a cavity in which a wire holder can be placed, e.g. a cavity of a housing. Herein, “internal latching mechanism” and “latching mechanism” can be used interchangeably.

Herein, the first end of the piercing terminal may be referred to as a piercing end. Herein, a wire can be an insulated wire.

Herein, the opposite inner wall of the housing can be opposite to the inner wall. The cavity (of the closeable housing) for holding the wire holder can be between the inner wall and opposite inner wall.

Herein, an arm can be a tab. The tab can extend along an extension direction parallel to the insertion direction. Perpendicular to the extension direction of the tab can be a long and a short axis, e.g. so that the tab has a rectangular cross section in a plane perpendicular to the extension direction/insertion direction.

Herein, the term “beveled side”, e.g. of a wire holder, can be used interchangeably with “beveled contact surfaces”.

Herein, a trailing(s) is used to indicate one or more. For example, an “arm(s)” means one or more arms. Herein a slash can indicate “and/or”. “And/or” means “‘and’ or ‘or’”. For example, “x/y” means “only x”, “only y”, or “x and y”.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. An insulation displacement connector, comprising:
at least one piercing terminal, for penetrating wire insulation and making electrical contact to a respective insulated wire in a wire holder; and
a closable housing including
a cavity, for holding the wire holder and the at least one piercing terminal, and
an internal latching mechanism; wherein
the cavity is configured for insertion of the wire holder along an insertion direction.

2. The insulation displacement connector as recited in claim 1, wherein
the latching mechanism extends, in the cavity, along the insertion direction.

3. The insulation displacement connector as recited in claim 1, wherein
the closable housing includes
a cover and base; wherein
the cover is configured to be latched to the base of the closable housing.

4. The insulation displacement connector as recited in claim 3, wherein
the internal latching mechanism is configured for at least one of:
latching the housing cover to the housing base;
latching the housing base to the wire holder.

5. The insulation displacement connector as recited in claim 1, wherein
the internal latching mechanism includes at least one arm, wherein
the at least one arm extends, along the insertion direction, from an inner wall of the closable housing when in a closed configuration; and
the at least one arm is at least one of:
configured to go through the wire holder in the cavity;
configured to pass next to the at least one piercing terminal;
insertable into a receptacle of the closable housing.

6. The insulation displacement connector as recited in claim 5, wherein
the at least one arm is configured to go through the wire holder and latch to at least one of:
an outer surface of the wire holder in the cavity;
the closable housing;
an inner surface of the closable housing;
another arm; or
a surface of the cavity.

7. The insulation displacement connector as recited in claim 5, wherein
the at least one arm is insertable into the receptacle of the closable housing; and
at least one of:
the cover of the housing includes the receptacle,
the base of the housing includes the receptacle, or
the receptacle is at a surface of the cavity.

8. The insulation displacement connector as recited in claim 5, wherein
a respective end of the at least one arm includes
a respective latching element; and wherein
the respective latching element is configured for at least one of:
latching to the wire holder in the cavity; or
latching the base and the cover of the closable housing together.

9. The insulation displacement connector as recited in claim 5, wherein
the latching mechanism includes at least one second arm, oriented along the insertion direction, that is configured to extend into or through the wire holder from an opposite inner wall of the closable housing.

10. The insulation displacement connector as recited in claim 9, wherein
the at least one arm and the at least one second arm are configured to latch together.

11. The insulation displacement connector as recited in claim 1, wherein
the at least one piercing terminal includes a piercing end extending along the insertion direction.

12. The insulation displacement connector as recited in claim 1, further comprising:
the wire holder, which includes
at least one window for providing the at least one piercing terminal access to the respective insulated wire in the wire holder; wherein optionally
the wire holder includes a pressing member for pressing the respective insulated wire against the at least one piercing terminal, for electrically contacting the at least one piercing terminal to the respective insulated wire, through the insulation of the respective insulated wire.

13. The insulation displacement connector as recited in claim 12, wherein:
the wire holder has beveled sides; the beveled sides being configured to contact inside walls of the closable housing.

14. The insulation displacement connector as recited in claim 12, wherein
the wire holder includes a holder base and holder cover; and in an assembled state of the wire holder, the holder base and holder cover form the at least one hole where the holder base and holder cover join.

15. A wire holder, comprising:
at least one window; wherein the at least one window is configured for passing a latching mechanism of a closable housing therethrough; wherein
the wire holder is configured to be inserted, along an insertion direction into a cavity of the closable housing;
the wire holder is configured to allow at least one piercing terminal, held in the cavity, to penetrate wire insulation and make electrical contact to a respective insulated wire held in the wire holder, when the wire holder is inserted into the cavity.
